(19) United States
(12) Patent Application Publication
(10) Pub. No.: US 2025/0253627 A1
(43) Pub. Date: Aug. 7, 2025

(54) COATING DEVICE AND METHOD FOR INSULATING PARALLEL GROOVE CLAMP

(71) Applicants: GUANGDONG POWER GRID CO., LTD., Guangzhou (CN); Heyuan Power Supply Bureau Of Guangdong Power Grid Corporation, Heyuan (CN)

(72) Inventors: Dingji ZENG, Heyuan (CN); Tuo ZENG, Heyuan (CN); Peijie LIU, Heyuan (CN); Junhui CHEN, Heyuan (CN); Yuanjun CHEN, Heyuan (CN)

(21) Appl. No.: 18/982,377

(22) Filed: Dec. 16, 2024

(30) Foreign Application Priority Data
Feb. 7, 2024 (CN) 202410173817.2

(51) Int. Cl. H02G 1/00

(52) U.S. Cl. CPC H02G 1/00

(57) ABSTRACT

Provided are a coating device and a method for insulating a parallel groove clamp. The coating device includes a feeding mechanism and a coating and curing mechanism. The feeding mechanism includes a material storage container and a push component. The material storage container is configured to contain liquid material. The push component is movably inserted into the material storage container. The coating and curing mechanism includes a forming mold. The forming mold has a forming cavity inside the forming mold. To-be-coated material is contained in the forming cavity. The forming cavity is in communication with the material storage container. The push component is configured to push the liquid material from the material storage container to the forming cavity. The liquid material is configured to be cured and coated on the outside of the to-be-coated material in the forming cavity.

### CROSS-REFERENCE TO RELATED APPLICATION

This application claims priority to Chinese patent application No. 202410173817.2 filed with the China National Intellectual Property Administration (CNIPA) on Feb. 7, 2024, the disclosure of which is incorporated herein by reference in its entirety.

### TECHNICAL FIELD

The present disclosure relates to the technical field of insulation treatment of distribution networks, in particular, a coating device and a method for insulating a parallel groove clamp.

### BACKGROUND

Currently, live-line connection work in distribution networks is typically performed manually, requiring manual work to strip cables under power and then connect grounding wires to corresponding cables. This manual method not only has low operational efficiency but also has a great operational safety risk. With the development of robotics technology, it is currently proposed to use robots and other intelligent devices to replace manual work in the process of live-line connection work. Robotic operations are efficient and can avoid the risk of electric shock to operators.

However, at present, robotic live-line connection work can only secure grounding wires to the exposed parts of conductors using parallel groove clamps, while subsequent manual work is still needed to add insulating protective covers over the parallel groove clamps to ensure insulation. The above method of adding insulating protective covers is inefficient and cannot guarantee the effectiveness of the insulation protection of the insulating protective covers on the parallel groove clamps.

Therefore, a coating device and a method for insulating a parallel groove clamp are urgently needed to solve the preceding problems.

### SUMMARY

The purpose of the present disclosure is to provide a coating device that can perform insulation treatment on a parallel groove clamp after the parallel groove clamp is wired, so as to form an integral insulation layer to enhance the insulation reliability and protection effectiveness of the parallel groove clamp.

To achieve this purpose, the present disclosure adopts the following technical solutions: The coating device includes a feeding mechanism and a coating and curing mechanism.

The feeding mechanism includes a material storage container and a push component. The material storage container is configured to contain liquid material. The push component is movably inserted into the material storage container.

The coating and curing mechanism includes a forming mold. The forming mold has a forming cavity inside the forming mold. To-be-coated material is contained in the forming cavity. The forming cavity is in communication with the material storage container.

The push component is configured to push the liquid material from the material storage container to the forming cavity. The liquid material is configured to be cured and coated on the outside of the to-be-coated material in the forming cavity.

In some embodiments, the coating device further includes a material conveying mechanism, and the material conveying mechanism is in communication with the material storage container and the forming cavity and is configured to convey the liquid material.

In some embodiments, the material conveying mechanism includes a first conveying pipe and a second conveying pipe that are separately in communication with the forming cavity, an inlet of the first conveying pipe and an inlet of the second conveying pipe are in communication with an outlet of the material storage container, and an outlet of the first conveying pipe and an outlet of the second conveying pipe are spaced apart in the forming mold.

In some embodiments, the push component includes a push rod and a push head, the push head is connected to the push rod, the push rod is coaxially and movably inserted into the material storage container, the push head is disposed in the material storage container, and the push rod pushes in an axial direction of the material storage container and is configured to drive the push head to push the liquid material out of the material storage container.

In some embodiments, the feeding mechanism further includes a feeding drive component connected to the push rod, and the feeding drive component is configured to drive the push rod to move in the axial direction of the material storage container.

In some embodiments, the feeding mechanism also includes a gear transmission component, and the feeding drive component is disposed on a side of the material storage container; the gear transmission component includes a first gear and a second gear that are in meshing connection with each other, and the push rod is a screw and is coaxially and spirally inserted into the second gear; and the first gear is connected to an output end of the feeding drive component, and the first gear is configured to rotate under the drive of the feeding drive component.

In some embodiments, the forming mold includes a first mold and a second mold, the distance between the first mold and the second mold is adjustable, and the first mold is docked with the second mold to form the forming cavity.

In some embodiments, the coating and curing mechanism also includes a mold drive component and a mold transmission component, the mold transmission component includes a lead screw and a guide rail, the lead screw is connected to an output end of the mold drive component, and the mold drive component is configured to drive the lead screw to rotate; the guide rail is arranged parallel to the lead screw and is connected to the first mold, the guide rail movably passes through the second mold, the lead screw is connected to the second mold in a threaded connection, and rotation of the lead screw is configured to drive the second mold to move close to or away from the first mold along the guide rail.

In some embodiments, two guide rails are provided, and the two guide rails are separately arranged parallel to the lead screw and are arranged on two sides of the lead screw at intervals.

The purpose of the present disclosure is to provide a method for insulating a parallel groove clamp, the method for insulating a parallel groove clamp adopts the coating device as described in any one of the preceding solutions to achieve insulation treatment of the parallel groove clamp, the to-be-coated material is the parallel groove clamp, and the liquid material is a liquid insulating material.

The method for insulating a parallel groove clamp includes the following:

In S1, the parallel groove clamp is placed in the forming cavity.

In S2, the push component is operated to inject the liquid insulating material into the forming cavity.

In S3, the liquid insulating material is cured and coated on an outside of the parallel groove clamp to form an insulation layer.

In S4, the coating and curing mechanism is disassembled.

The beneficial effects of the present disclosure are described below.

The coating device provided by the present disclosure includes a feeding mechanism and a coating and curing mechanism. The feeding mechanism includes a material storage container and a push component. The material storage container is configured to contain liquid material. The push component is movably inserted into the material storage container. The push component can push the liquid material in the material storage container to the outlet of the storage container. The coating and curing mechanism includes a forming mold. The forming mold has a forming cavity inside the forming mold. To-be-coated material is contained in the forming cavity. The forming cavity is in communication with the outlet of the material storage container. That is, the push component is configured to push the liquid material from the material storage container to the forming cavity. The liquid material is coated on the outside of the to-be-coated material under the restriction of the cavity wall of the forming cavity. The coating device can achieve the rapid coating and molding of liquid material on the outside of the to-be-coated material. The to-be-coated material may be a parallel groove clamp. The liquid material may be a liquid insulating material. The coating device can perform insulation treatment on the parallel groove clamp after the parallel groove clamp is wired, so as to form an integral insulation layer to enhance the insulation reliability and protection effectiveness of the parallel groove clamp.

### BRIEF DESCRIPTION OF DRAWINGS

FIG. 1 is a diagram illustrating the structure of a coating device according to an embodiment of the present disclosure.

FIG. 2 is a diagram illustrating the structure of a feeding mechanism according to an embodiment of the present disclosure.

FIG. 3 is a diagram illustrating the structure of a coating and curing mechanism and a parallel groove clamp according to an embodiment of the present disclosure.

FIG. 4 is a sectional view of a coating and curing mechanism and a parallel groove clamp according to an embodiment of the present disclosure.

### REFERENCE LIST

10 parallel groove clamp
20 conductor
100 feeding mechanism
110 material storage container
120 push component
121 push rod
130 feeding drive component
140 gear transmission component
141 first gear
142 second gear
150 bracket
200 coating and curing mechanism
210 forming mold
211 first mold
212 second mold
213 first injection port
214 second injection port
220 forming cavity
230 mold drive component
240 mold transmission component
241 lead screw
242 guide rail
251 first base
252 second base
253 quick-release port
300 material conveying mechanism
310 first conveying pipe
320 second conveying pipe

### DETAILED DESCRIPTION

The present disclosure is further described hereinafter in detail in conjunction with drawings and embodiments. It is to be understood that the embodiments described herein are intended to explain the present disclosure and not to limit the present disclosure. Additionally, it is to be noted that for ease of description, only part, not all, of the structures related to the present disclosure are illustrated in the drawings.

In the description of the present disclosure, unless otherwise expressly specified and limited, the term “connected to each other”, “connected”, or “secured” is to be construed in a broad sense, for example, as securely connected, detachably connected, or integrated; mechanically connected or electrically connected; directly connected to each other or indirectly connected to each other via an intermediary; or internally connected between two components or interaction relations between two components. For those of ordinary skill in the art, specific meanings of the preceding terms in the present disclosure may be construed based on specific situations.

In the present disclosure, unless otherwise expressly specified and limited, when a first feature is described as “above” or “below” a second feature, the first feature and the second feature may be in direct contact or be in contact via another feature between the two features. Moreover, when the first feature is “on”, “above”, or “over” the second feature, the first feature is right on, above, or over the second feature, or the first feature is obliquely on, above, or over the second feature, or the first feature is simply at a higher level than the second feature. When the first feature is “under”, “below”, or “underneath” the second feature, the first feature is right under, below, or underneath the second feature, or the first feature is obliquely under, below, or underneath the second feature, or the first feature is simply at a lower level than the second feature.

In the description of the embodiments, orientations or position relations indicated by terms such as “above”, “below”, “right”, and “left” are based on orientations or position relations shown in the drawings. These orientations or position relations are intended only to facilitate and simplify the operation, and not to indicate or imply that a device or element referred to must have such specific orientations or must be configured or operated in such specific orientations. Thus, these orientations or position relations are not to be construed as limiting the present disclosure. In addition, terms “first” and “second” are used only to distinguish between descriptions and have no special meaning.

### Embodiment One

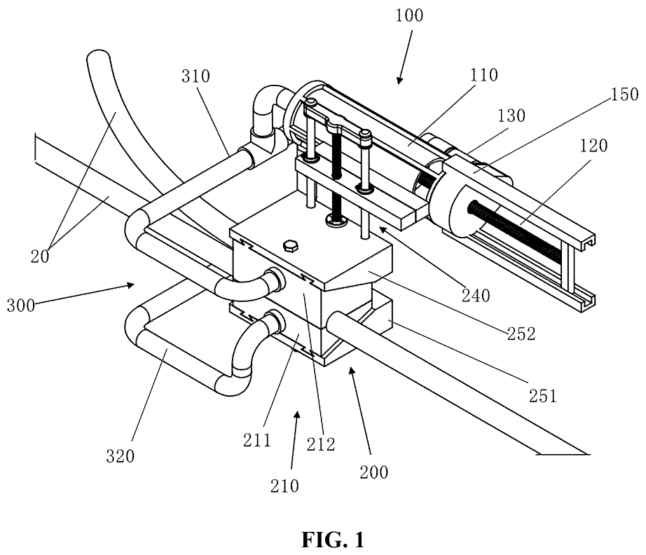

FIG. 1 is a diagram illustrating the structure of a coating device according to an embodiment of the present disclosure. With reference to FIG. 1, this embodiment provides a coating device. The coating device can insulate the parallel groove clamp 10 disposed at the exposed part of conductors 20 and form an integral insulation layer on the outside of the parallel groove clamp 10 to improve the insulation effect.

In this embodiment, the coating device includes a feeding mechanism 100, a coating and curing mechanism 200, and a material conveying mechanism 300. The feeding mechanism 100 is in communication with the coating and curing mechanism 200 through the material conveying mechanism 300. The coating and curing mechanism 200 is able to be wrapped outside the to-be-coated material. The feeding mechanism 100 is able to contain liquid material. The coating and curing mechanism 200 is able to guide the liquid material in the feeding mechanism 100 to the coating and curing mechanism 200. In this embodiment, the to-be-coated material is a parallel groove clamp 10 that completes the wiring work, and the liquid material is a liquid insulating material.

In some embodiments, the feeding mechanism 100 includes a material storage container 110 and a push component 120, the material storage container 110 is configured to contain a liquid insulating material, and the push component 120 is movably inserted into the material storage container 110. The coating and curing mechanism 200 includes a forming mold 210. The forming mold 210 has a forming cavity 220 inside the forming mold 210. The parallel groove clamp 10 is contained in the forming cavity 220. The forming cavity 220 is in communication with the material storage container 110. The push component 120 is configured to push the liquid insulating material from the material storage container 110 to the forming cavity 220, and the liquid insulating material is configured to be cured and coated on the outside of the parallel groove clamp 10 in the forming cavity 220. After being cured, the liquid insulating material is able to form an insulation layer that completely covers the outside of the parallel groove clamp 10. The material conveying mechanism 300 is in communication with the material storage container 110 and the forming cavity 220 and is able to be used to convey the liquid insulating material.

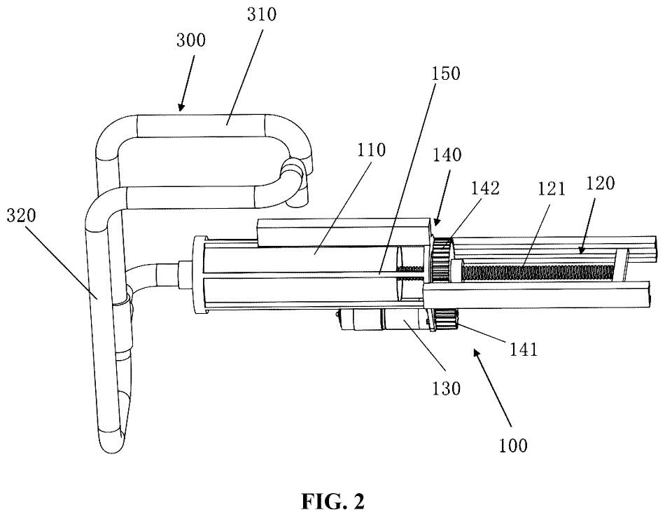

FIG. 2 is a diagram illustrating the structure of a feeding mechanism according to an embodiment of the present disclosure. With reference to FIGS. 1 and 2, the push component 120 includes a push rod 121 and a push head. The push head is connected to one end of the push rod 121. The push rod 121 is coaxially and movably inserted into the material storage container 110. The push head is disposed in the material storage container 110, and the side of the push head is completely in contact with the inner cavity wall of the material storage container 110. The push rod 121 pushes in the axial direction of the material storage container 110 and is configured to drive the push head to move toward the outlet of the end of the material storage container 110 in the axial direction to push the liquid insulating material out of the material storage container 110.

In some embodiments, the push component 120 may be manually driven, and an operator applies a thrust to the end of the push rod 121 away from the push head to achieve the movement of the push head in the material storage container 110.

In some embodiments, the feeding mechanism 100 further includes a feeding drive component 130. The feeding drive component 130 is connected to the push rod 121 and is configured to drive the push rod 121 to move in the axial direction of the material storage container 110. With the preceding arrangement, the labor intensity of the operator can be reduced.

In some embodiments, the feeding drive component 130 may be a hydraulic cylinder connected to the end of the push rod 121 away from the push head, and the push rod 121 is pushed by hydraulic pressure.

In some embodiments, the feeding drive component 130 may also be a rotating motor arranged on the side of the material storage container 110. The feeding mechanism 100 further includes a gear transmission component 140. The gear transmission component 140 includes a first gear 141 and a second gear 142 that are in meshing connection with each other. The push rod 121 is a screw that is coaxially and spirally inserted into the second gear 142. The first gear 141 is connected to the output end of the rotating motor, and the first gear 141 is able to rotate simultaneously under the rotation of the output end of the rotating motor. Since the first gear 141 and the second gear 142 are in meshing connection with each other, the second gear 142 is able to rotate at the same time, thereby driving the screw to rotate. Since the screw is coaxially and spirally inserted into the second gear 142, and the second gear 142 is fixed relative to the material storage container 110 by a bracket 150 and is located at one end in the axial direction of the material storage container 110, the screw is able to move in the axial direction of the material storage container 110 while rotating.

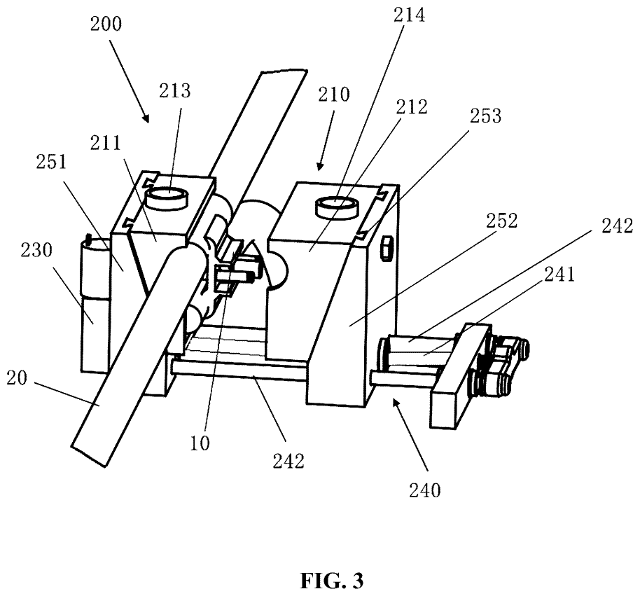

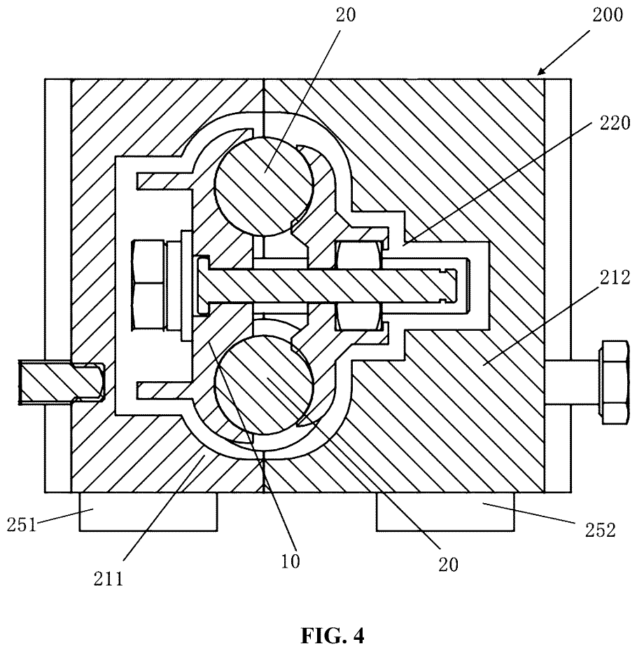

FIG. 3 is a diagram illustrating the structure of a coating and curing mechanism and a parallel groove clamp according to an embodiment of the present disclosure. FIG. 4 is a sectional view of a coating and curing mechanism and a parallel groove clamp according to an embodiment of the present disclosure. With reference to FIGS. 1, 3, and 4, the forming mold 210 includes a first mold 211 and a second mold 212. The distance between the first mold 211 and the second mold 212 is adjustable. When the first mold 211 is docked with the second mold 212, a forming cavity 220 is formed.

In some embodiments, the coating and curing mechanism 200 further includes a mold drive component 230 and a mold transmission component 240. The mold drive component 230 is a motor. The mold transmission component 240 includes a lead screw 241 and a guide rail 242. The lead screw 241 is connected to the rotational output end of the mold drive component 230, and the mold drive component 230 is able to drive the lead screw 241 to rotate. The guide rail 242 is arranged parallel to the lead screw 241 and is fixedly connected to the first mold 211. The guide rail 242 relatively moves through the second mold 212. The lead screw 241 is connected to the second mold 212 in a threaded connection. The mold drive component 230 drives the lead screw 241 to rotate and is configured to drive the second mold 212 to move close to or away from the first mold 211 along the guide rail 242.

In some embodiments, two guide rails 242 are provided, and the two guide rails 242 are separately arranged parallel to the lead screw 241 and are arranged on two sides of the lead screw 241 at intervals. With the preceding arrangement, the second mold 212 can improve the stability of the movement when the second mold 212 moves close to or away from the first mold 211 under the limitation of the two guide rails 242.

In some embodiments, the coating and curing mechanism 200 may further include a first base 251 and a second base 252 that are detachably connected. The guide rail 242 is fixedly connected to the first base 251, and the second base 252 is slidably inserted into the guide rail 242. On the sides of the first base 251 and the second base 252 that face each other, a first mounting slot and a second mounting slot are provided, respectively. The first mounting slot is configured to securely hold the first mold 211, and the second mounting slot is configured to securely hold the second mold 212.

In some embodiments, the first base 251 is configured to be engaged with the second base 252, and quick-release ports 253 are disposed at the relative locations of the upper end surface of the first base 251 and the upper end surface of the second base 252. For different parallel groove clamps 10, the quick-release ports 253 are provided to facilitate the installation of the first mold 211 and the second mold 212 corresponding to different parallel groove clamps 10 on the first base 251 and the second base 252, respectively.

With continued reference to FIG. 1 to FIG. 3, the material conveying mechanism 300 includes a first conveying pipe 310 and a second conveying pipe 320 that are separately in communication with the forming cavity 220. The inlet of the first conveying pipe 310 and the inlet of the second conveying pipe 320 are both in communication with the outlet disposed at the axial end of the material storage container 110 through a connection pipe. The outlet of the first conveying pipe 310 and the outlet of the second conveying pipe 320 are spaced apart in the forming mold 210. The arrangement of the first conveying pipe 310 and the second conveying pipe 320 can improve the uniformity of the liquid insulating material entering the forming cavity 220 and improve the efficiency of the liquid insulating material filling the forming cavity 220.

In some embodiments, the first mold 211 is provided with a first injection port 213, the second mold 212 is provided with a second injection port 214, and the first conveying pipe 310 and the second conveying pipe 320 can be in communication with the first injection port 213 and the second injection port 214 by quick plugging, respectively.

### Embodiment Two

This embodiment provides a method for insulating a parallel groove clamp. The method for insulating a parallel groove clamp uses the coating device provided in embodiment one to perform insulation treatment on the parallel groove clamp 10. The to-be-coated material is the parallel groove clamp 10, and the liquid material is a liquid insulating material.

The method for insulating a parallel groove clamp specifically includes the following steps:

In S1, the parallel groove clamp 10 is placed in the forming cavity 220.

First, the parallel groove clamp 10 is clamped in the first mold 211, and the mold drive component 230 and the mold transmission component 240 are used to make the second mold 212 close to and abut against the first mold 211 so that the parallel groove clamp 10 is sealed in the forming cavity 220.

In S2, the push component 120 is operated to inject the liquid insulating material into the forming cavity 220.

In S3, the liquid insulating material is cured and coated on the outside of the parallel groove clamp 10 to form an insulation layer.

In S4, the coating and curing mechanism 200 is disassembled, and the insulation treatment of the parallel groove clamp 10 is completed.

Apparently, the preceding embodiments of the present disclosure are only illustrative of the present disclosure and are not intended to limit the implementations of the present disclosure. Those of ordinary skill in the art can make various apparent modifications, adaptations, and substitutions without departing from the scope of the present disclosure. All embodiments cannot be and do not need to be exhausted herein. Any modifications, equivalent substitutions, and improvements made within the spirit and principle of the present disclosure fall within the scope of the claims of the present disclosure.

What is claimed is:

1. A coating device, comprising:
a feeding mechanism, wherein the feeding mechanism comprises a material storage container and a push component, the material storage container is configured to contain liquid material, and the push component is movably inserted into the material storage container; and
a coating and curing mechanism, wherein the coating and curing mechanism comprises a forming mold, the forming mold has a forming cavity inside the forming mold, to-be-coated material is contained in the forming cavity, and the forming cavity is in communication with the material storage container;
wherein the push component is configured to push the liquid material from the material storage container to the forming cavity, and the liquid material is configured to be cured and coated on an outside of the to-be-coated material in the forming cavity.

2. The coating device of claim 1, further comprising a material conveying mechanism, wherein the material conveying mechanism is in communication with the material storage container and the forming cavity and is configured to convey the liquid material.

3. The coating device of claim 2, wherein the material conveying mechanism comprises a first conveying pipe and a second conveying pipe that are separately in communication with the forming cavity, an inlet of the first conveying pipe and an inlet of the second conveying pipe are in communication with an outlet of the material storage container, and an outlet of the first conveying pipe and an outlet of the second conveying pipe are spaced apart in the forming mold.

4. The coating device of claim 1, wherein the push component comprises a push rod and a push head, the push head is connected to the push rod, the push rod is coaxially and movably inserted into the material storage container, the push head is disposed in the material storage container, and the push rod pushes in an axial direction of the material storage container and is configured to drive the push head to push the liquid material out of the material storage container.

5. The coating device of claim 4, wherein the feeding mechanism further comprises a feeding drive component connected to the push rod, and the feeding drive component is configured to drive the push rod to move in the axial direction of the material storage container.

6. The coating device of claim 5, wherein the feeding mechanism further comprises a gear transmission component, and the feeding drive component is disposed on a side of the material storage container;
the gear transmission component comprises a first gear and a second gear that are in meshing connection with each other, and the push rod is a screw and is coaxially and spirally inserted into the second gear; and
the first gear is connected to an output end of the feeding drive component, and the first gear is configured to rotate under drive of the feeding drive component.

7. The coating device of claim 1, wherein the forming mold comprises a first mold and a second mold, a distance between the first mold and the second mold is adjustable, and the first mold is docked with the second mold to form the forming cavity.

8. The coating device of claim 2, wherein the forming mold comprises a first mold and a second mold, a distance between the first mold and the second mold is adjustable, and the first mold is docked with the second mold to form the forming cavity.

9. The coating device of claim 3, wherein the forming mold comprises a first mold and a second mold, a distance between the first mold and the second mold is adjustable, and the first mold is docked with the second mold to form the forming cavity.

10. The coating device of claim 7, wherein the coating and curing mechanism further comprises a mold drive component and a mold transmission component, the mold transmission component comprises a lead screw and a guide rail, the lead screw is connected to an output end of the mold drive component, and the mold drive component is configured to drive the lead screw to rotate; the guide rail is arranged parallel to the lead screw and is connected to the first mold, the guide rail movably passes through the second mold, the lead screw is connected to the second mold in a threaded connection, and rotation of the lead screw is configured to drive the second mold to move close to or away from the first mold along the guide rail.

11. The coating device of claim 10, wherein two guide rails are provided, and the two guide rails are separately arranged parallel to the lead screw and are arranged on two sides of the lead screw at intervals.

12. A method for insulating a parallel groove clamp, wherein the method for insulating a parallel groove clamp adopts the coating device of claim 1 to achieve insulation treatment of the parallel groove clamp, the to-be-coated material is the parallel groove clamp, and the liquid material is a liquid insulating material; and
the method for insulating a parallel groove clamp comprises:
placing the parallel groove clamp in the forming cavity;
operating the push component to inject the liquid insulating material into the forming cavity;
curing and coating the liquid insulating material on an outside of the parallel groove clamp to form an insulation layer; and
disassembling the coating and curing mechanism.

13. A method for insulating a parallel groove clamp, wherein the method for insulating a parallel groove clamp adopts the coating device of claim 2 to achieve insulation treatment of the parallel groove clamp, the to-be-coated material is the parallel groove clamp, and the liquid material is a liquid insulating material; and
the method for insulating a parallel groove clamp comprises:
placing the parallel groove clamp in the forming cavity;
operating the push component to inject the liquid insulating material into the forming cavity;
curing and coating the liquid insulating material on an outside of the parallel groove clamp to form an insulation layer; and
disassembling the coating and curing mechanism.

14. A method for insulating a parallel groove clamp, wherein the method for insulating a parallel groove clamp adopts the coating device of claim 3 to achieve insulation treatment of the parallel groove clamp, the to-be-coated material is the parallel groove clamp, and the liquid material is a liquid insulating material; and
the method for insulating a parallel groove clamp comprises:
placing the parallel groove clamp in the forming cavity;
operating the push component to inject the liquid insulating material into the forming cavity;
curing and coating the liquid insulating material on an outside of the parallel groove clamp to form an insulation layer; and
disassembling the coating and curing mechanism.

15. A method for insulating a parallel groove clamp, wherein the method for insulating a parallel groove clamp adopts the coating device of claim 4 to achieve insulation treatment of the parallel groove clamp, the to-be-coated material is the parallel groove clamp, and the liquid material is a liquid insulating material; and
the method for insulating a parallel groove clamp comprises:
placing the parallel groove clamp in the forming cavity;
operating the push component to inject the liquid insulating material into the forming cavity;
curing and coating the liquid insulating material on an outside of the parallel groove clamp to form an insulation layer; and
disassembling the coating and curing mechanism.

16. A method for insulating a parallel groove clamp, wherein the method for insulating a parallel groove clamp adopts the coating device of claim 5 to achieve insulation treatment of the parallel groove clamp, the to-be-coated material is the parallel groove clamp, and the liquid material is a liquid insulating material; and
the method for insulating a parallel groove clamp comprises:
placing the parallel groove clamp in the forming cavity;
operating the push component to inject the liquid insulating material into the forming cavity;
curing and coating the liquid insulating material on an outside of the parallel groove clamp to form an insulation layer; and
disassembling the coating and curing mechanism.

17. A method for insulating a parallel groove clamp, wherein the method for insulating a parallel groove clamp adopts the coating device of claim 6 to achieve insulation treatment of the parallel groove clamp, the to-be-coated material is the parallel groove clamp, and the liquid material is a liquid insulating material; and
the method for insulating a parallel groove clamp comprises:
placing the parallel groove clamp in the forming cavity;
operating the push component to inject the liquid insulating material into the forming cavity;
curing and coating the liquid insulating material on an outside of the parallel groove clamp to form an insulation layer; and
disassembling the coating and curing mechanism.

18. A method for insulating a parallel groove clamp, wherein the method for insulating a parallel groove clamp adopts the coating device of claim 7 to achieve insulation treatment of the parallel groove clamp, the to-be-coated material is the parallel groove clamp, and the liquid material is a liquid insulating material; and
the method for insulating a parallel groove clamp comprises:
placing the parallel groove clamp in the forming cavity;
operating the push component to inject the liquid insulating material into the forming cavity;
curing and coating the liquid insulating material on an outside of the parallel groove clamp to form an insulation layer; and
disassembling the coating and curing mechanism.

19. A method for insulating a parallel groove clamp, wherein the method for insulating a parallel groove clamp adopts the coating device of claim 8 to achieve insulation treatment of the parallel groove clamp, the to-be-coated material is the parallel groove clamp, and the liquid material is a liquid insulating material; and
the method for insulating a parallel groove clamp comprises:
placing the parallel groove clamp in the forming cavity;
operating the push component to inject the liquid insulating material into the forming cavity;
curing and coating the liquid insulating material on an outside of the parallel groove clamp to form an insulation layer; and
disassembling the coating and curing mechanism.

20. A method for insulating a parallel groove clamp, wherein the method for insulating a parallel groove clamp adopts the coating device of claim 9 to achieve insulation treatment of the parallel groove clamp, the to-be-coated material is the parallel groove clamp, and the liquid material is a liquid insulating material; and
the method for insulating a parallel groove clamp comprises:
placing the parallel groove clamp in the forming cavity;
operating the push component to inject the liquid insulating material into the forming cavity;
curing and coating the liquid insulating material on an outside of the parallel groove clamp to form an insulation layer; and
disassembling the coating and curing mechanism.
